(19) United States
(12) Patent Application Publication
(10) Pub. No.: US 2023/0334433 A1
(43) Pub. Date: Oct. 19, 2023

(54) USAGE-BASED PREVENTIVE TERMINAL MAINTENANCE

(71) Applicant: NCR Corporation, Atlanta, GA (US)

(72) Inventors: Kun Zhu, Smyrna, GA (US); Andrew Jeremy Adamec, Buford, GA (US); Nimeelitha Akkiraju, Atlanta, GA (US); Yung-Hang Chang, Marietta, GA (US); Jason Wayne Taylor, Suwanee, GA (US)

(21) Appl. No.: 17/659,693

(22) Filed: Apr. 19, 2022

(51) Int. Cl. G06Q 10/00

(52) U.S. Cl. CPC G06Q 10/20

(57) ABSTRACT

Transaction usage metrics for terminals and maintenance records for the terminals are evaluated in view of suggested maintenance actions for peripherals and/or components of the peripherals associated with the terminals. Any open service records for terminals predicted to require a maintenance action based on the evaluation have the maintenance action added to their open service records. A new open service record is generated for any terminal predicted to require the maintenance action based on the evaluation when an existing open service record for the corresponding terminal was not detected. In an embodiment, service calls associated with the open service records are monitored for compliance and non-compliant actions are flagged for reporting.

### BACKGROUND

Self-Checkout (SCO) lanes in retail stores allow customers to shop and checkout items at their own convenience. SCOs were introduced in the industry to save on labor costs and reduce theft. When a SCO fails, it does not only negatively affect shoppers’ experience, the intervention needed as a result of failures also reduces the productivity of the store.

Media handling devices comprise the largest single reason that SCOs fail. These media handling devices include printers, bank note and coin recyclers. The primary purposes of these devices are to dispense and/or to accept cash, coins, checks, and/or paper. Wear and tear on the mechanical components associated with the media being processed through the handling devices occur more frequently than other mechanical components of the SCOs. Consequently media handling components require cleaning frequently otherwise failures will occur more frequently related to media jams.

Moreover, since the whole point of a SCO is to permit customers to perform self-checkouts without attendants, the operating environment is not as controlled as that which is associated with cashier-assisted terminals (Point-Of-Sale (POS) terminals). Customers may stick foreign objects into the handling devices such as badly damaged media, torn media, dirty media, or even non-media items. The customers may become frustrated and force media that is being rejected into the media infeed components, etc.

Of course other mechanical components of SCOs also experience failures albeit on a less frequent basis. Such components may comprise, card readers, scanners, weigh scales, keypads, touch displays, etc.

As a result, there is a need to provide predictive and usage-based preventive maintenance actions on SCOs before the SCOs actually fail for purposes of improving the operational up time of the SCOs, reducing customer frustrations, and improving resource costs.

### SUMMARY

In various embodiments, methods and a system for usage-based predictive maintenance on terminals are presented.

According to an embodiment, a method for usage-based predictive maintenance on terminals. Specifically, and in one embodiment, a data model is generated from maintenance guides of peripherals of terminals. The maintenance guides comprise usage limits and maintenance actions on components of the peripherals. Transaction usage metrics are obtained from the terminals. A predicted maintenance action is generated for at least one of the components on at least one of the peripherals associated with at least one of the terminals based on a comparison of the corresponding transaction usage metrics and the corresponding usage limits defined for the at least one of the components in the corresponding data model.

### BRIEF DESCRIPTION OF THE DRAWINGS

FIG. 1 is a diagram of a system for usage-based predictive maintenance on terminals, according to an example embodiment.

FIG. 2 is a diagram of a method for usage-based predictive maintenance on terminals, according to an example embodiment.

FIG. 3 is a diagram of another method for usage-based predictive maintenance on terminals, according to an example embodiment.

### DETAILED DESCRIPTION

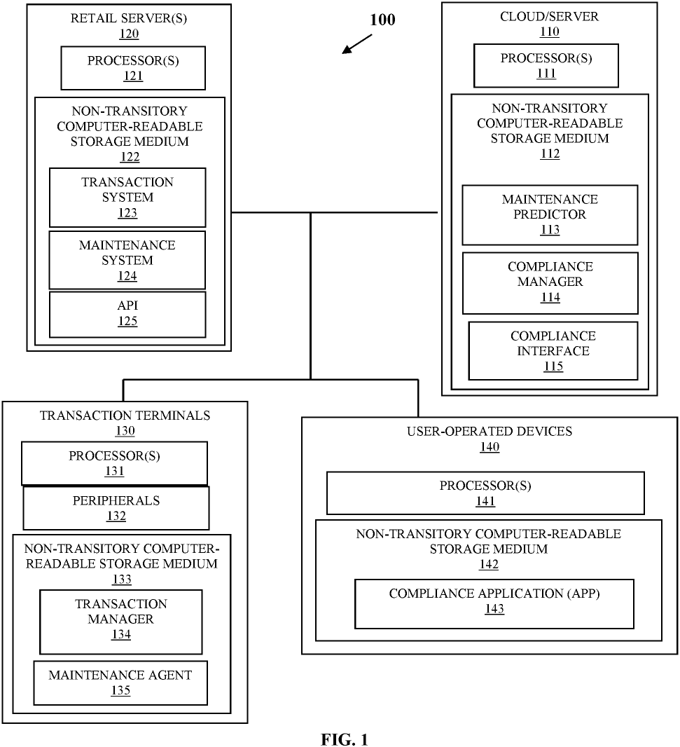

FIG. 1 is a diagram of a system 100 for usage-based predictive maintenance on terminals, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from usage-based predictive maintenance on terminals teachings presented herein and below.

Moreover, various components are implemented as one or more software modules, which reside in non-transitory storage and/or hardware memory as executable instructions that when executed by one or more hardware processors perform the processing discussed herein and below.

System 100 provides proactive and data-driven predictions for preventive maintenance of components of transaction terminals. The type of preventive maintenance is identified with the predictions along with the specific terminal identifiers. Moreover, managed terminals and their maintenance records (including predictive maintenance actions) are compared against non-managed terminals and their maintenance record, demonstrating that the operational time of the managed terminals and the maintenance cycles of the managed terminals (managed by system 100) are improvements over the non-managed terminals (those not managed by system 100). Further, actual maintenance actions performed for the predictive maintenance actions are monitored for compliance, non-compliant predictive maintenance actions are reported to improve maintenance action compliance for a given retailer. Metrics are obtained for the components of the terminals; usage patterns are maintained for the components; and the metrics are compared against maintenance action requirements known for each component type in view of the usage patterns to determine a predictive maintenance action on any given component of any given terminal.

Support tickets and schedules for the terminals and/or for the components of the terminals are considered based on current totaled metrics and current usage patterns for the components for purposes of accelerating a predictive maintenance action before a threshold value is reached for the given component of the given terminal so as to avoid multiple in-person maintenance actions by a technician within a given interval of time.

Still further, when a technician performs a maintenance action at a given terminal, additional metrics are collected for the maintenance action, and the technician is asked to complete a compliance questionnaire. The additional metrics and answers to the questionnaire are evaluated for non-compliance and reported to the retailer for subsequent review by the retailer with the technician and to improve maintenance compliance within a given store of the retailer.

As used herein the term “component” refers to a mechanical device of a peripheral device of a terminal. The component may be a sensor, a belt, a hopper, an infeed coin chute, an outfeed coin chute, an infeed paper-based media port, and outfeed paper-based media port, a media cassette, a transport path, a basket, a drive (motor), a print head, an illumination source, a media diverter, a scale, a lens, a spine, a loader, a media accepter, a media dispenser, a scanner window, a card port, etc. A peripheral device may be, by way of example only, a scanner, a weigh scale, a combined scanner-weigh scale, a basket scale, a camera, a microphone, a keypad, a touch display, a media depository, a media dispenser, a media recycler, a card reader, a printer, a cash drawer, a coin accepter, a coin dispenser, a coin recycler, etc. Each peripheral is a specific peripheral type, each component of each peripheral is a specific component type.

A “maintenance action” refers to component/peripheral manufacturer’s suggested actions as defined in the peripheral’s manual on a given component when predefined conditions are met or when specific events are detected during operation of the given component. By way of example only, a maintenance action may comprise, cleaning a sensor, replacing a sensor, replacing a belt, replacing a drive, replacing a component, sending a component to an authorized organization for off-site repair or replacement, etc.

The maintenance actions are classified into a hierarchical level comprising level 1 for cleaning on site, level 2 component replacement on site, and level 3 comprehensive component replacement offsite.

A “predictive maintenance action” is a system 100 generated maintenance action suggested as being required on a component of a given peripheral of a given terminal based on the usage-based analysis discussed herein and below. A predictive maintenance action may also be referred to as a “preventive maintenance action” herein and below.

A “support ticket” refers to a record generated by a retailer’s maintenance system that identifies one or more maintenance actions that are to be performed by a given technician who the maintenance system assigned the support ticket to.

It is within this initial context that various embodiments of the usage-based predictive maintenance on terminals is discussed with reference to FIGS. 1-3.

System 100 comprises a cloud/server 110, a retail server(s) 120, transaction terminals 130, and user-operated devices 140.

Cloud/Server 110 comprises at least one processor 111 and a non-transitory computer-readable storage medium 112. Medium 112 comprises executable instructions for a maintenance predictor 113, a compliance manager 114, and compliance interface 115. When the processor 111 obtains or is provided the executable instructions from medium 112, this causes the at processor 111 to perform the operations discussed herein and below with respect to 113-115.

Each retail server 120 at least one processor 121 and a non-transitory computer-readable storage medium 122. Medium 122 comprises executable instructions for a transaction system 123, maintenance system 124, and an Application Programming Interface (API) 125. When the processor 121 obtains or is provided the executable instructions from medium 122, this causes the at processor 121 to perform the operations discussed herein and below with respect to 123-125.

Each transaction terminal 130 comprises at least one processor 131, peripheral devices (peripherals) 132, and a non-transitory computer-readable storage medium 133. Medium 133 comprises executable instructions for a transaction system 134 and a maintenance agent 135. When the processor 131 obtains or is provided the executable instructions from medium 133, this causes the at processor 131 to perform the operations discussed herein and below with respect to 134-135.

Each user-operated device 140 comprises at least one processor 141 and a non-transitory computer readable storage medium 142. Medium 140 comprises executable instructions for a compliance application (app) 143. When the executable instructions are provided to corresponding processor 141 from medium 142, this causes processor 141 to perform operations discussed herein and below for 143.

Initially, a data store is established that comprises the maintenance or user guides for the peripherals 132 based on peripheral type and version number. Each peripheral maintenance or user guide also comprises maintenance actions for each component type and version number of each component associated with the corresponding peripheral 132. The maintenance or user guide comprises conditions and events associated with necessitating or triggering each maintenance action. Moreover, each transaction terminal identifier for a given transaction terminal 130 is linked to a plurality of peripheral maintenance of user guides based on the peripheral types and version numbers of the peripherals 132 associated with the corresponding terminal 130. The data store is processed to create a data model for each terminal 130 by terminal identifier, the model is a data structure comprising records of the data store that corresponding to the components, maintenance actions, the conditions, and the events.

Additionally, each data model includes a threshold or set of thresholds for the conditions and events of each component. The threshold or set of thresholds are below hard coded thresholds defined in the conditions. For example, suppose that a media transport belt is associated with a maintenance action of replacing the belt based on a condition that a hard coded number X of media items were processed on the corresponding media depository (a type of peripheral 132). Each data model is configured with a configurable and changeable additional threshold or set of thresholds defined as X-Y where Y is less than X by a configured amount. Multiple different conditions for the depository may have X has a hard coded threshold, each condition having X can have a different threshold, such that there are a set of configurable thresholds; for instance a second condition of X may include a configured threshold of X-Z. These thresholds or set of thresholds can be changed based on observed performance of system 100 in view of observed maintenance records of each of the terminals 130, each of the peripherals 132, and/or each of the components.

During operation of system 100, transactions are processed on the terminals 130 by transaction managers 134. During each transaction, metrics are captured by maintenance agent 135. The metrics may include, by way of example only, a transaction calendar data, transaction time of day, transaction terminal identifier for the transaction terminal 130, store identifier for a store that has terminal 130, a retail identifier for a retailer associated with the store, transaction total, payment type (card, cash, check, in-store credit), any cash received by denomination, any change provided (cash and/or coin) by denomination, total number of items scanned for the transaction, total number of items weighed for the transaction, receipt printed (yes of no), etc. Maintenance agent 135 also reports statuses of each peripheral 132 with each transaction within the metrics. For example, a printer status may be detected as ink is at 25% in receipt printer, etc. So, agent 135 reports metrics along with any event or status for the given transaction. Transaction manager 134 interacts with transaction system 123 to complete each transaction for a given retailer at a given store associated with terminal 130.

Agent 135 provides the metrics after each transaction or in batches of transaction metrics at configurable intervals of time to maintenance system 124. In an embodiment, agent 135 may directly provide the metrics to maintenance predictor 113 (after each transaction or in batches at configurable intervals of time). When the metrics are provided to maintenance system 124, maintenance system 124 sends the metrics to maintenance predictor 113 using API 125.

Additionally, maintenance records for each terminal 130 is obtained by predictor 113 via API 125. Predictor 113 may request specific maintenance records for specific terminals via API 125 and/or maintenance system 124 may send maintenance records when scheduled (open support tickets) and when completed (completed support tickets).

Predictor 113 uses as input the data models, the metrics, and the maintenance records (scheduled and completed). Usage patterns are computed for each terminal 130, such as average daily cash payment transactions, average cash payment transaction per hour of a given day, average transactions per day, average transactions per hour of a given day, average total items scanned per transaction per day and/or per hour of a given day, average total number of items weighed per transaction per day and/or per hour of a given day, etc. Historical usage patterns are maintained per terminal 130 and linked to the corresponding data model.

Predictor 113 also mines the maintenance record per terminal 130 and maintains a period of time between repeated maintenance actions, usage patterns between the repeated maintenance actions for the period of time, and current usage patterns relative to the period of time. Metric totals are also maintained for each metric between repeated maintenance actions and current metric totals for each metric relative to the period of time.

Predictor 113 than compares the current metric totals and current usage totals relative to the period of time during which a repeated maintenance action was performed in view of a current elapsed time from a last performance of the maintenance action to identify a predicted date and time that the repeated maintenance action will likely be needed. Predictor also compares the current metric totals against the data model and its conditions and events to adjust, if needed, the predicted date and time that the maintenance action will be needed.

Next, predictor 113 identifies the terminals 130, the peripherals 132, and the components associated with the predicted data and time that the maintenance action will be needed and further inspects the maintenance records for any open or scheduled maintenance records (open support tickets). These open support tickets are inspected for the predicted maintenance action and if they lack the predicted maintenance action, predictor 113 uses API 125 to add the predicted maintenance action to the corresponding open support tickets. This ensures that a corresponding terminal 130 with an open support ticket includes the predicted maintenance action in the open support ticket so that when the technician services the terminal 130 for the original maintenance actions, the technician is also informed via the support ticket to perform the predicted maintenance action.

Any remaining open support ticket that did not include the predicted maintenance action is further inspected by obtaining the current metric totals for the terminals associated with the remaining open support tickets and comparing the current metric totals against the configurable thresholds of set of thresholds. That is, terminals with open support tickets and a current metric total that does not meet the corresponding data model’s hard coded threshold are compared against the configurable threshold(s) and if the current metric totals are within the configurable threshold, predictor also adds the maintenance action into those terminals’ open support tickets using API 125 to interact with maintenance system 124. In this way efficiency is achieved so that a technician visit during an existing open support ticket to a given terminal 130 can include a cost-effective predictive maintenance action even when such action is not yet technically required by the corresponding manual defined in the corresponding data model for that terminal 130.

Any terminals 130 that are not the subject of any existing open support ticket but that do have the predictive maintenance action based on the current usage totals are identified by predictor 113. Predictor 113 uses API 125 to interact with maintenance system 124 and create an open support ticket for the corresponding terminals to perform the predictive maintenance action.

Predictor 113 also continually monitors the support tickets for the terminals 130 and time periods between repeated maintenance actions, when a given time period falls below a threshold period of time for a given terminal 130. The configurable thresholds defined in the corresponding data model is increased so as to avoid repeated same maintenance actions within the threshold period of time.

Predictor 113 may also monitor support tickets for terminals that are not being managed and compare the average time periods between a repeated maintenance action on the managed terminals 130 against the non-managed terminals. Adjustments to the configurable thresholds in the corresponding data models are made to ensure that average time periods between repeated maintenance actions on the managed terminals 130 remains greater than the average time periods between repeated maintenance actions on the non-managed terminals. This also provides demonstrable proof that system 100 improves terminal 130 up time, the number of open tickets per terminal 130, and improved staff scheduling of maintenance when compared to non-managed terminals.

Compliance manager 114 is notified via maintenance system 124 when a technician is at a terminal 130 to perform maintenance operations of an open support ticket. Additionally or alternatively, an added processing step in a workflow associated with an open support ticket causes that compliance manager 114 to be invoked when a technician is at a terminal 130 to perform maintenance operations of an open support ticket. Compliance manager 114 maintains a checklist data model for each maintenance operation and engages the technician via compliance interface 115 through a compliance application 143 that processes on the technician’s mobile device 140. The checklist of items is presented through interface 115 within app 143 and the technician is asked to confirm each task associated with the maintenance action was performed by the technician through app 143. Any non-confirmed task is flagged and reported back maintenance system 124 and/or a predefined resource. In some cases, the flagged tasks and corresponding technicians and maintenance action are batched together and reported out at predefined intervals of time. Tallies of flagged tasks per technician and/or per maintenance action can be reported. Details associated with each flag can be retrieved via a link in the reports, such as calendar day, time of day, technician identifier, terminal identifier, open ticket identifier, maintenance action identifier, etc.

In an embodiment, maintenance agent 135 maintains additional metrics during a service call by a technician for an open support ticket, such as time stamp a door or bay to a given peripheral was opened and closed during the service call by the technician, etc. The additional metrics are reported to compliance manager 114 after each service call. The elapsed time that the door or bay was opened can be computed by compliance manager 114 from the open bay time stamp and the close bay time stamp. The elapsed time may fall below a threshold defined in a given checklist, such that the checklist item can be flagged by compliance manager 114 as a non-compliant checklist item for the maintenance action. That is the checklist can include metadata associated with the additional metrics which when detected indicates that a given checklist item has to be or is most likely non-compliant. Again, this can be reported in the manners discussed above.

In an embodiment, the transaction terminals 130 can be Self-Service Terminals (SSTs), POS terminals, Automated Teller Machines (ATMs), and/or kiosks.

In an embodiment, user-operated devices 140 can be phones, tablets, laptops, and/or wearable processing devices.

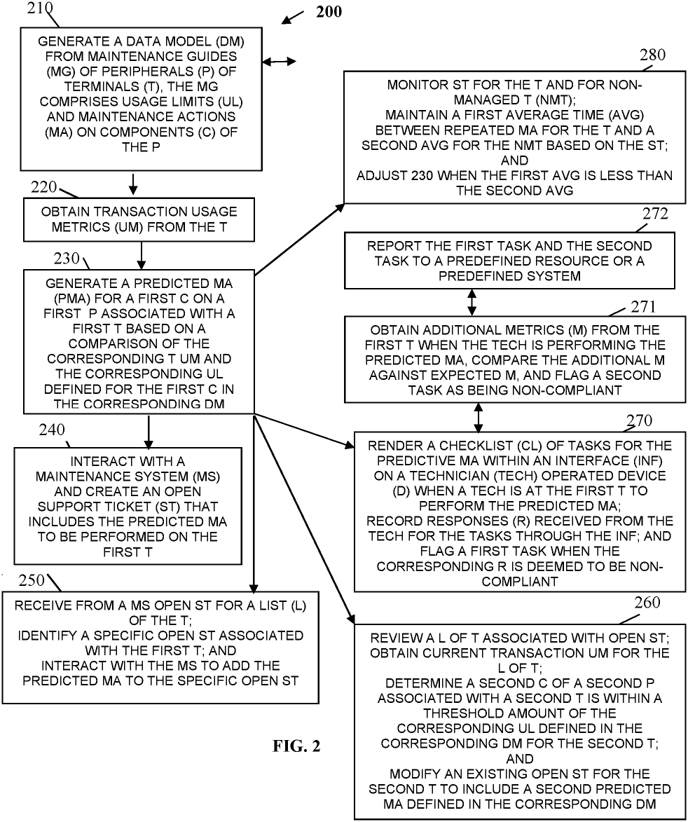

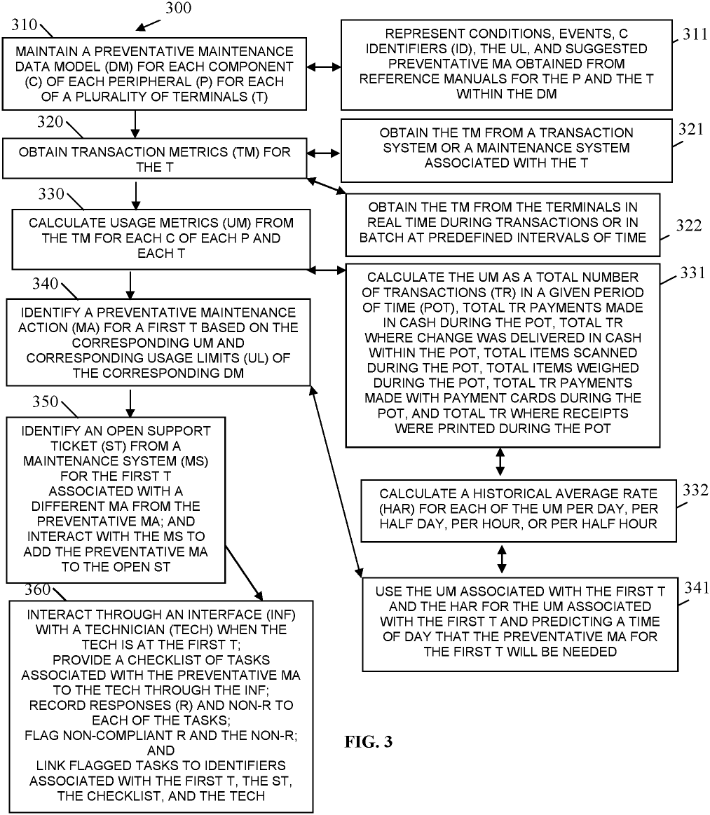

The embodiments of FIG. 1 and other embodiments are now discussed with reference to the FIGS. 2-3.

FIG. 2 is a diagram of a method 200 for usage-based predictive maintenance on terminals, according to an example embodiment. The software module(s) that implements the method 200 is referred to as a “predictive terminal maintenance manager.” The predictive terminal maintenance manager is implemented as executable instructions programmed and residing within memory and/or a non-transitory computer-readable (processor-readable) storage medium and executed by a plurality of hardware processors of a plurality of hardware computing devices. The processors of the devices that execute the predictive terminal maintenance manager are specifically configured and programmed to process the predictive terminal maintenance manager. The predictive terminal maintenance manager has access to one or more networks during its processing. The networks can be wired, wireless, or a combination of wired and wireless.

In an embodiment, the devices that execute the predictive terminal maintenance manager is cloud 110 and/or server 110.

In an embodiment, the predictive terminal maintenance manager is all or some combination of 113, 114, and/or 115.

At 210, the predictive terminal maintenance manager generates a data model from maintenance guides of peripherals 132 of terminals 130. The maintenance guide comprises usage limits and maintenance actions on components of the peripherals 132.

At 220, the predictive terminal maintenance manager obtains transaction usage metrics from the terminals.

At 230, the predictive terminal maintenance manager generates a predicted maintenance action for a first component on a first peripheral 132 associated with a first terminal 130 based on comparison of the corresponding transaction usage metrics and the corresponding usage limit defined for the first component in the corresponding data model.

In an embodiment, at 240, the predictive terminal maintenance manager interacts with a maintenance system 124 and creates an open support ticket that includes the predicted maintenance action to be performed on the first terminal.

In an embodiment, at 250, the predictive terminal maintenance manager receives from a maintenance system 124 open support tickets for a list of the terminals. The predictive terminal maintenance manager identifies a specific open support ticket associated with the first terminal and the predictive terminal maintenance manager interacts with the maintenance system 124 to add the predicted maintenance action to the specific open support ticket as an added task to the support ticket.

In an embodiment, at 260, the predictive terminal maintenance manager reviews a list of terminals associated with open support tickets and obtains current transaction usage metrics for each of the terminals in the list. The predictive terminal maintenance manager determines a second component of a second peripheral 134 associated with a second terminal 130 is within a threshold amount of the corresponding usage limit defined in the corresponding data model for the second terminal 130. The predictive terminal maintenance manager modifies an existing open support ticket for the second terminal 130 to include a second predicted maintenance action defined in the corresponding data model.

In an embodiment, at 270, the predictive terminal maintenance manager renders a checklist of tasks for the predictive maintenance action within an interface 115 on a technician operated device 140 (via app 143) when a technician is at the first terminal to perform the predicted maintenance action. The predictive terminal maintenance manager records responses received from the technician for the tasks through the interface 115. The predictive terminal maintenance manager flags a first task when the corresponding response is deemed to be non-compliant.

In an embodiment of 270 and at 271, the predictive terminal maintenance manager obtains additional metrics from the first terminal 130 when the technician is performing the predicted maintenance action. The predictive terminal maintenance manager compares the additional metrics against expected metrics and flags a second task as being non-compliant based on the comparison.

In an embodiment of 271 and at 272, the predictive terminal maintenance manager reports the first task and the second task to a predefined resource of a predefined system (such as maintenance system 124).

In an embodiment, at 280, the predictive terminal maintenance manager monitors support tickets for the terminals 130 and for non-managed terminals. The predictive terminal maintenance manager maintains a first average time between repeated maintenance actions for the terminals 130 and maintains a second average time between the repeated maintenance actions for the non-managed terminals. The predictive terminal maintenance manager adjust 230 when the first average time is less than the second average time.

FIG. 3 is a diagram of another method 300 for usage-based predictive maintenance on terminals, according to an example embodiment. The software module(s) that implements the method 300 is referred to as a “preventive maintenance manager.” The preventive maintenance manager is implemented as executable instructions programmed and residing within memory and/or a non-transitory computer-readable (processor-readable) storage medium and executed by one or more hardware processors of one or more hardware devices. The processors of the devices that execute the preventive maintenance manager are specifically configured and programmed to process the preventive maintenance manager. The preventive maintenance manager has access to one or more networks during its processing. The networks can be wired, wireless, or a combination of wired and wireless.

The preventive maintenance manager presents another and, in some ways, enhanced processing perspective of that which was described above with the method 200.

In an embodiment, cloud 110 executes the preventive maintenance manager. In an embodiment, server 110 executes the preventive maintenance manager.

In an embodiment, the preventive maintenance manager is all or some combination of 113, 114, 115, 143, and/or method 200.

At 310, the preventive maintenance manager maintains a preventative maintenance data model for each component of each peripheral 134 for each of a plurality of terminals 130.

In an embodiment, at 311, the preventive maintenance manager represents conditions, events, component identifiers, usage limits, and suggested preventative maintenance actions obtained from reference manuals for the peripherals 134 and the terminals 130 within the preventative maintenance data model.

At 320, the preventive maintenance manager obtains transaction metrics for the terminals.

In an embodiment, at 321, the preventive maintenance manager obtains the transaction metrics from a transaction system 123 or a maintenance system 124 associated with the terminals 130.

In an embodiment, at 322, the preventive maintenance manager obtains the transaction metrics from the terminals 130 in real time during transactions or in batch at predefined intervals of time.

At 330, the preventive maintenance manager calculates usage metrics from the transaction metrics for each component of each peripheral 134 and each terminal 130.

In an embodiment, at 331, the preventive maintenance manager calculates the usage metrics as a total number of transaction in a given period of time, total transaction payments made in cash during the given period of time, total transactions where change was delivered in cash within the given period of time, total items scanned during the given interval of time, total items weighed during the given period of time, total transaction payments made with payment cards during the given period of time, and total transactions where receipts were printed during the given interval of time.

In an embodiment of 331 and at 332, the preventive maintenance manager calculates a historical average rate for each of the usage metrics per day, per half day, per hour, or per half hour.

At 340, the preventive maintenance manager identifies a preventative maintenance action for a first terminal 130 based on the corresponding usage metrics and corresponding usage limits of the corresponding data model.

In an embodiment of 332 and 340, at 341, the preventive maintenance manager uses the usage metrics associated with the first terminal 130 and the historical average rate for the usage metrics associated with the first terminal 130 and predicts a time of day that the preventative maintenance action for the first terminal 130 will be needed.

In an embodiment, at 350, the preventive maintenance manager identifies an open support ticket from a maintenance system 124 for the first terminal 130 that is associated with a different maintenance action from the preventative maintenance action. The preventive maintenance manager interacts with the maintenance system 124 to add the preventative maintenance action to the open support ticket.

In an embodiment of 350 and at 360, the preventive maintenance manager interacts through an interface 115 with a technician via app 143 when the technician is at the first terminal 130 to perform the preventative maintenance action for the open support ticket. The preventive maintenance manager provides a checklist of tasks associated with the preventative maintenance action to the technician through the interface 115 via app 143. The preventive maintenance manager records responses and non-responses to each of the tasks (received through the interface 115) and the preventive maintenance manager links flagged tasks to identifiers associated with the first terminal 130, the open support ticket being processed by the technician, the checklist, and the technician.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
generating a data model from maintenance guides of peripherals of terminals, wherein the maintenance guides comprise usage limits and maintenance actions on components of the peripherals;
obtaining transaction usage metrics from the terminals; and
generating a predicted maintenance action for a first component on at a first peripheral associated with a first terminal based on a comparison of the corresponding transaction usage metrics and the corresponding usage limits defined for the first component in the corresponding data model.

2. The method of claim 1 further comprising, interacting with a maintenance system and creating an open support ticket that includes the predicted maintenance action to be performed on the first terminal.

3. The method of claim 1 further comprising:
receiving from a maintenance system open support tickets for a list of the terminals;
identifying a specific open support ticket associated with the first terminal; and
interacting with the maintenance system to add the predicted maintenance action to the specific open support ticket.

4. The method of claim 1 further comprising:
receiving from a maintenance system open support tickets for a list of the terminals;
determining that the first terminal is not included in the list; and
interacting with the maintenance system to add a new open support ticket for the predicted maintenance action on the first terminal.

5. The method of claim 1 further comprising:
reviewing a list of terminals associated with open support tickets;
obtaining current transaction usage metrics for the list of terminals;
determining that a second component of a second peripheral associated with a second terminal is within a threshold amount of the corresponding usage limits defined in the corresponding data model for the second terminal, wherein the second terminal is included in the list of terminals; and
modifying an existing open support ticket for the second terminal to include a second predicted maintenance action defined in the corresponding data model.

6. The method of claim 1 further comprising:
rendering a checklist of tasks for the predictive maintenance action within an interface on a technician operated device when a technician is at the first terminal to perform the predicted maintenance action;
recording responses received from the technician for the tasks through the interface; and
flagging a first task when the corresponding response is deemed to be non-compliant.

7. The method of claim 1, wherein rendering further includes obtaining additional metrics from the first terminal when the technician is performing the predicted maintenance action, comparing the additional metrics against expected metrics, and flagging a second task as being non-compliant based on the comparing.

8. The method of claim 7 further comprising, reporting the first task and the second task to a predefined resource or a predefined system.

9. The method of claim 1 further comprising:
monitoring support tickets for the terminals and for non-managed terminals;
maintaining a first average time between repeated maintenance action for the terminals and a second average time between the repeated maintenance actions for the non-managed terminals based on the support tickets; and
adjusting the generating of the predicted maintenance action when the first average time is less than the second average time.

10. A method, comprising:
maintaining a preventative maintenance data model for each component of each peripheral foreach of a plurality of terminals based on usage limits for each component;
obtaining transaction metrics for the terminals;
calculating usage metrics from the transaction metrics for each component of each peripheral and each terminal;
identifying a preventive maintenance action for a first terminal based on the corresponding usage metrics and the corresponding usage limits of the corresponding preventative maintenance data model.

11. The method of claim, wherein maintaining further includes representing conditions, events, component identifiers, the usage limits, and suggested preventative maintenance actions obtained from reference manuals for the peripherals and the terminals within the preventative maintenance data models.

12. The method of claim 10, wherein obtaining further includes obtaining the transaction metrics from a transaction system or a maintenance system associated with the terminals.

13. The method of claim 10, wherein obtaining further includes obtaining the transaction metrics from the terminals in real time during transactions or in batch at predefined intervals of time.

14. The method of claim 10, wherein calculating further includes calculating the usage metrics as total number of transactions in a given period of time, total transaction payments made in cash within the given period of time, total transactions where change was delivered in cash within the given period of time, total items scanned within the given period of time, total items weighed during the given interval time, total transaction payments made with payment cards during the given interval of time, and total transactions where receipts were printed during the given interval of time.

15. The method of claim 14, wherein calculating further includes calculating a historical average rate for each of the usage metrics per day, per half day, per hour, or per half hour.

16. The method of claim 15, wherein identifying further includes using the usage metrics associated with the first terminal and the historical average rates for the usage metrics associated with the first terminal and predicting a time of day that the preventative maintenance action for the first terminal will be needed.

17. The method of claim 10 further comprising:
identifying an open support ticket from a maintenance system for the first terminal associated with a different maintenance action from the preventative maintenance action; and
interacting with the maintenance system to add the preventive maintenance action to the open support ticket.

18. The method of claim 17 further comprising:
interacting through an interface with a technician when the technician is at the first terminal to address the open support ticket;
providing a checklist of tasks associated with the preventative maintenance action to the technician through the interface;
recording responses or non responses to each of the tasks;
flagging non-compliant responses and the non-responses; and
linking flagged tasks to identifiers associated with the first terminal, the open support ticket, the checklist, and the technician.

19. A system comprising:
a cloud comprising a plurality of servers;
each server comprising at least one processor and a non-transitory computer-readable storage medium;
each non-transitory computer-readable storage medium comprising executable instructions;
the executable instructions when provided to or obtained by the corresponding processor from the corresponding non-transitory computer-readable storage medium cause the corresponding processor to perform operations, comprising :
comparing current usage metrics for components of peripherals associated with terminals against suggested usage limits defined in reference manuals for the terminals;
identifying a first terminal with the corresponding current usage metrics within a threshold of the corresponding usage limit, at the corresponding usage limit, or over the corresponding usage limit for a given component of a given peripheral associated with the first terminal;
obtaining a preventative maintenance action defined in the corresponding reference manual for the given component; and
interacting with a maintenance system to create a support ticket for the terminal to have a technician perform the preventative maintenance action on the given component.

20. The system of claim 19, wherein the first terminal is a Self-Service Terminal or an Automated Teller Machine, and wherein the given peripheral is a media recycler, a media depository, or a media dispenser.
